(19) United States
(12) Patent Application Publication
(10) Pub. No.: US 2008/0189781 A1
(43) Pub. Date: Aug. 7, 2008

(54) REMOTE MANAGEMENT OF ELECTRONIC DEVICES

(75) Inventors: Rabindra Pathak, Vancouver, WA (US); Eric Thomas Olbricht, Vancouver, WA (US)

Correspondence Address: LAW OFFICES OF LARRY K. ROBERTS, INC., 2 PARK PLAZA, SUITE 300, IRVINE, CA, 92614, US

(73) Assignee: Sharp Laboratories of America, Inc.

(21) Appl. No.: 11/670,604

(22) Filed: Feb. 2, 2007

(51) Int. Cl. G06F 15/173; G06F 21/20

(52) U.S. Cl. 726/12; 709/223

(57) ABSTRACT

A system and method for remotely managing a device connected on an intranet may include opening a private and secure communication channel between a management gateway connected on the intranet behind a firewall and a remote management console connected to the internet.

### BACKGROUND

Dealers or service personnel typically do not have a secure mechanism to manage systems or devices installed inside the protected networks of a customer. Such systems or devices may include, for example and without limitation, multifunction printing (MFP) devices, capable of multiple printing and imaging functions, e.g. print, scan, copy and print, or subsets of these functions. In the MFP example, a dealer may manage a multitude of MFPs located at multiple customer sites. The dealer or service staff typically would be physically present at the customer site in order to install, configure, diagnose and service MFPs. In order to manage these devices, dealers may send staff to customer sites which is time consuming and costly.

### SUMMARY OF THE DISCLOSURE

A method and system for remotely managing a device connected on an intranet may include opening a private and secure communication channel between a management gateway connected on the intranet and a remote management console connected to the internet.

### BRIEF DESCRIPTION OF THE DRAWINGS

FIG. 1 depicts an exemplary embodiment of a remote management system, depicting an exemplary interaction between a remote system such as a dealer system and a user system such as a customer system.

FIG. 2 depicts a flow chart for an exemplary embodiment of a management gateway to establish and maintain a secure virtual tunnel between the remote system and the user system.

FIG. 3 depicts an exemplary embodiment of a sample request/response flow between a remote management console and management gateway to manage a device such as an MFP in a user system from a remote location.

### DETAILED DESCRIPTION

In the following detailed description and in the several figures of the drawing, like elements are identified with like reference numerals. The figures are not to scale, and relative feature sizes may be exaggerated for illustrative purposes.

An exemplary embodiment of a remote management system and method may provide a real-time, on-demand and standards-based secure technique to remotely manage a device or system, such as an MFP device. An exemplary embodiment of a system and method may include a “Management Gateway” and “Remote Management Console”. A management gateway may be installed inside the customer network. A remote management console may be installed at dealer site. The dealer may use the remote management console to communicate with the management gateway which in turn communicates to customer MFPs. The dealer may have access to only the management gateway. The rest of the customer network including the customer MFPs may be protected from the direct access of the dealer. The dealer may not be able to access any part of the customer network other than the management gateway. The management gateway in turn accesses the MFPs to carry out further device management on the dealer's request. Access to the management gateway may be granted only to the intended dealer and may be protected using industry-standard security protocols.

An exemplary embodiment of a system and method may provide various remote control and command capabilities to dealers to carry out device management, service and diagnosis of MFPs located inside customer premises from dealer locations, including one or more of the following: firmware upgrades, reboot, front panel access, feature cloning, device cloning, security dashboard, status update, click count, driver distribution, supply management, preventive maintenance, job accounting, and browsing the embedded web page of MFP.

An exemplary embodiment of a management system and method may include one or more of the following:

Direct and one to one secure connection between a dealer remote management console and a customer gateway.

Real-time and on-demand access to customer MFPs for diagnosis, service and management.

Remote management of the MFP devices, installed inside the protected customer networks, without opening up the customer firewall.

An exemplary embodiment may not add a hardware component for each MFP, and hence may scale from a few MFPs to thousands of MFPs easily and cost-efficiently.

An exemplary embodiment may employ standards-based protocols for communication between a dealer and customer systems.

Though an exemplary embodiment is described in the context of remote management of MFP devices, and may be useful for printing and imaging devices, the technology may be applied to many other application areas. For example, the technology may be used to manage computer networks remotely, and to manage the network devices remotely.

In an exemplary illustrative application, a manufacturer may distribute devices such as MFPs through dealers, who in turn sell the MFPs to customers. The dealers support and maintain the MFPs for their customers. A dealer typically may have multiple customers. In the past, a dealer service staff may be physically present in the customer premises in order to install, configure and service the MFPs. Usually MFPs are behind the firewall of the customer's computer network, and the dealer cannot access them from within the dealer network. In this exemplary application, a system and method is provided to enable a dealer to securely manage the MFPs from the dealer location. A mechanism may be provided through an exemplary embodiment of the system and method for dealers to perform device management tasks such as, for example, firmware (FW) updating, device rebooting, device cloning and front panel access remotely from the dealer location.

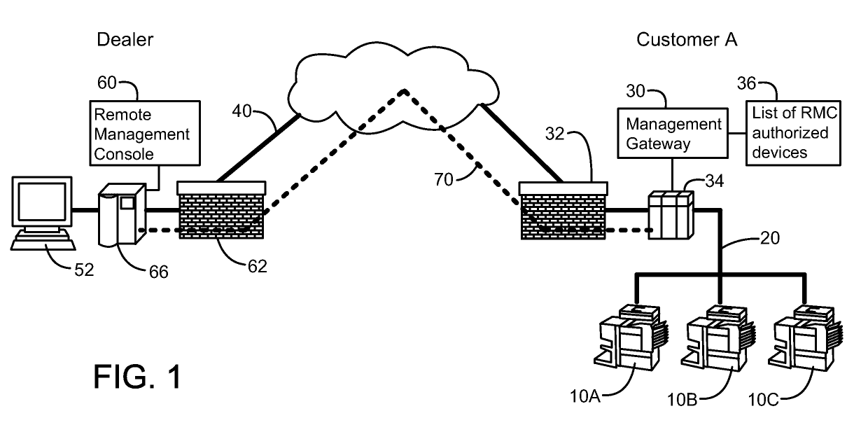

FIG. 1 depicts an exemplary interaction between dealer and customer systems. Customer A has a number of MFPs 10A, 10B, 10C connected on its intranet 20. While FIG. 1 depicts three exemplary MFP devices, it is to be understood that a customer may have a network of any number of devices, including possibly hundreds of MFPs. A management gateway 30 is installed on a server 34, also connected on the intranet, and is used to manage all the MFPs. In an exemplary embodiment, the management gateway 30 may be implemented as a software application. The management gateway 30, the server 34 and the MFPs 10A, 10B, 10C are all secured from unauthorized outside access by a customer firewall 32, through which a connection to the internet 40 is made.

In an exemplary embodiment, a dealer has a software application referred to herein as a remote management console 60 which may be used to remotely manage the customer MFPs 10A,10B, 10C. The remote management console may be installed onto a server 66 connected with a terminal or PC 52 at the dealer's site. The remote management console 60 may be secured behind the firewall 62 of the dealer. In an exemplary embodiment, the dealer may open his HTTPS port in order for the remote management console 60 to communicate with the management gateway 30 installed at the customer site.

An exemplary embodiment of a management system may provide the remote management console 60 and the management gateway 30 with a persistent secure virtual tunnel 70 through which the remote management console can communicate with the management gateway. In an exemplary embodiment, the secure virtual tunnel may be an authenticated and encrypted communication link which is persistent or quasi-persistent, i.e., stays on after an exchange of messages. This secure virtual tunnel may provide a private and secure channel of communication between remote management console and management gateway over a public and non-secure medium such as the internet. To further enhance the security, the secure virtual tunnel also ensures that dealer can not access any other part of customer network except the Management Gateway. In an exemplary embodiment, the management gateway 30 may maintain a white list of all the devices which the remote management console is to be permitted to control remotely. Only the management gateway will access those devices. If the remote management console were to ask to control any other devices remotely on the customer intranet, the management gateway would refuse the request.

There are several ways in which a persistent secure virtual tunnel can be established, and which option is used in a particular customer scenario is a function of ease of deployment, scalability and level of security needed. In an exemplary embodiment, the URI scheme known as HTTPS may serve as a primary mechanism to establish a persistent secure virtual tunnel. HTTPS is well known in the art, and refers to Hypertext Transfer Protocol over Secure Socket Layer, or HTTP over SSL. HTTPS is a Web protocol built into browsers that encrypts and decrypts user page requests as well as the pages that are returned by a Web server. HTTPS uses the Secure Socket Layer (SSL) as a sub layer under the HTTP application layering. HTTPS uses port 443 instead of HTTP port 80 in its interactions with the lower layer, TCP/IP.

In an exemplary embodiment using HTTPS, the management gateway 30 may initiate an outgoing connection to the remote management console 60, and the secure tunnel 70 is established after mutual authentication based on digital certificates. Then the management gateway 30 authorizes the remote management console 60 for remote management of the MFP devices 10A, 10B, 10C. At the successful end of an authorization step, a secure tunnel 70 is in place. Since the connection was initiated from within the firewall of the customer and it is an outgoing connection, there may be no need to open a hole in the customer firewall 32. This exemplary embodiment may not require customers to make any changes in their existing firewall, e.g. in cases in which outgoing connections are not blocked by a firewall.

An exemplary embodiment employs HTTPS polling as a mechanism to obtain a persistent connection. HTTPS connections are by their nature non-persistent. HTTPS connections can be dropped for various reasons. Usually if the connection is idle for a certain period of time, then some intermediate network device (e.g. a firewall, a proxy, network address translation (NAT), a router or gateway, a Web Server, etc.) will drop the connection. In an exemplary HTTPS polling mechanism, the management gateway 30 periodically sends small HTTPS request packets in order to preempt the idle timeout and waits for response from the remote management console 60. When the management gateway receives the response, it knows that the HTTPS connection is up. If the management gateway 30 does not get a response within a certain time interval or gets a network message that the connection is dropped, then the management gateway starts the secure tunnel establishment process all over again. Thus, in spite of intermittent disconnects (which may be largely unnoticeable by users), this exemplary embodiment simulates a persistent connection.

While an exemplary embodiment has been described which uses HTTPS as a mechanism to establish a secure virtual tunnel and HTTPS polling to make this tunnel persistent, other techniques may alternatively be employed. For example, in addition to HTTPS polling, other options which may be supported by the management gateway 30 include use of instant messaging, SMS (Simple Messaging Service) and MMS (Multi-media Messaging Service) to simulate the persistent behavior. In this alternative, whenever the remote management console wishes to communicate with the management gateway, then it sends an instant message, SMS or MMS to the management gateway and the management gateway may establish a secure virtual tunnel with the remote management console using HTTPS. In this alternative, the instant message, SMS or MMS may be a communication request message sent from the remote management console to the management gateway via a second communication channel which is different from the secure virtual tunnel. The second communication channel may be a secure or non-secure channel, or an encrypted or non-encrypted link. A HTTPS connection may not always exist between the remote management console and the management gateway, though it is almost always available on demand through instant messaging, SMS or MMS.

An exemplary embodiment may also use a virtual private network (VPN) as one of the options to establish a persistent secure virtual tunnel. A persistent secure virtual tunnel established using a VPN provides very high security but it is less scalable due to the need for one to one VPN between dealer and each customer. As the number of customers increases, the need for hardware and software needed multiplies quickly and hence this solution may be more expensive to deploy and scale.

An exemplary embodiment of a secure virtual tunnel may use SSL and Digital Certificates for encryption and authentication. An exemplary embodiment may also use username/password based authorization for additional security.

In an exemplary embodiment, a secure virtual tunnel may be firewall friendly because it may obviate opening up the customer firewalls. Since the management gateway 30 actually initiates an outbound HTTPS connection to the remote management console 60, the customers in some cases may not need to modify their firewall settings.

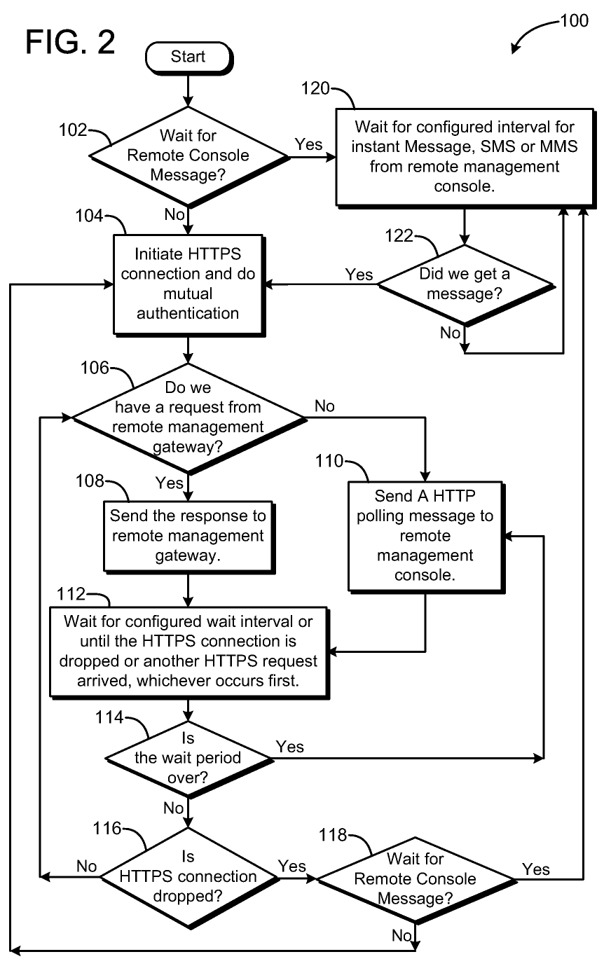

FIG. 2 depicts a flow chart of an exemplary method 100 for a management gateway (MG) to establish and maintain a secure virtual tunnel with a remote management console (RMC). At 102, the MG operation will proceed to 104 if not awaiting a message from the RMC, or to 120 if awaiting an RMC message. At 104, the MG initiates an HTTPS connection with the RMC, and mutual authentication is performed. If at 106 a request is made from the RMC, a response will be sent from the MG to the RMC at 108, which may provide a status of complying with the RMC request, for example. If no request has been made at 106, a HTTP polling message is sent at 110 to the RMC. At 112, operation waits for a configured wait interval or until the HTTPS connection is dropped or another HTTPS request is received, which ever occurs first. In an exemplary embodiment, the wait interval may be user configurable, with a user having the capability of changing from a default time interval value. At 114, if the wait period has expired, operation returns to 112. At 116, operation returns to 106 if the HTTPS connection has not been dropped. If the connection has been dropped, at 118, operation will be returned to 104 if not waiting for an RMC message. If the system is waiting for an RMC message at 118, operation proceeds to 120. At step 120, operation waits for a configured interval for an instant message, SMS or MMS from the RMC. If at 122 a message has been received, operation proceeds to 104 to initiate a HTTPS connection and perform a mutual authentication.

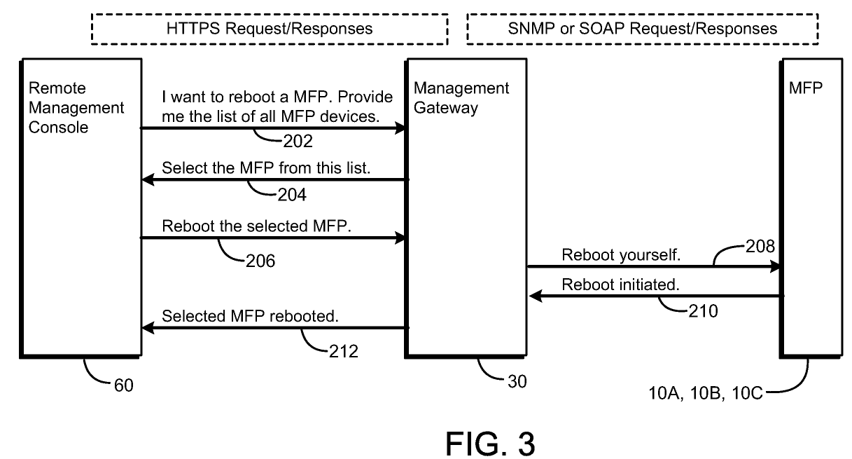

FIG. 3 depicts an exemplary sample request/response flow between a remote management console 60 and a management console 30 to manage a MFP 10A, 10B or 10C from a dealer location. In this example, the dealer wishes to perform the remote reboot of a MFP located in the customer premises. Communication between the remote management console 60 and the management gateway 30 takes place using the HTPPS protocol. The management gateway may communicate with the MFP using SNMP, SOAP or any other protocol configured in the management gateway 30. The simple network management protocol (SNMP) forms part of the internet protocol suite as defined by the Internet Engineering Task Force (IETF). SNMP is used by network management systems to monitor network-attached devices for conditions that warrant administrative attention. It includes a set of standards for network management, including an Application Layer protocol, a database schema, and a set of data objects. SOAP represents “Simple Object Access Protocol,” a lightweight XML-based messaging protocol used to encode the information in Web service request and response messages before sending them over a network. SOAP messages are independent of any operating system or protocol and may be transported using a variety of Internet protocols, including SMTP, MIME, and HTTP.

For the example illustrated in FIG. 3, the dealer wishes to reboot a remote MFP. The dealer through the remote management console 60 sends a request message 202 to the management gateway to send a list of all MFPs which can be rebooted remotely. The management gateway 30 retrieves the list from its white list 36 (FIG. 1) and provides the list in a response message 204. The dealer through the remote management console 60 selects the desired MFP and sends a request 206 to the management gateway 30 to reboot the selected MFP, e.g., MFP 10A. The management gateway in turn sends a request 208 to the selected MFP 10A to reboot, using SNMP, SOAP or another protocol supported by the MFP. The MFP initiates the reboot and sends a confirmation response 210 to the management gateway 30. The management gateway 30 sends a confirmation response as a HTTPS response message 212 to the remote management console 60.

The activity depicted in FIG. 3 is merely exemplary of a remotely actuated reboot process. Similar interactions may be used to carry out other remote management, diagnostics and service operations, e.g. the diagnostic and service operations described below.

Once the persistent secure virtual connection is established between the remote management console and the management gateway, then the remote management console is able to manage, service and diagnose the MFP devices with the help of the management gateway. The remote management console may ask the management gateway to perform the following exemplary activities on the customer MFPs which are accessible to the management gateway: firmware upgrade; reboot; front panel access; feature cloning; device cloning; a security dashboard (a “dashboard” which displays the current network configurations; for example it may show if the FTP port on the MFP is enabled or disabled,; status update; click count (a count of total pages printed, faxed and copied by the MFP, i.e. a kind of meter reading to denote the usage of the MFP); driver distribution; supply management; preventive maintenance; job accounting; and browsing the embedded web page of an MFP.

Although the foregoing has been a description and illustration of specific embodiments of the subject matter, various modifications and changes thereto can be made by persons skilled in the art without departing from the scope and spirit of the subject matter as defined by the following claims.

What is claimed is:

1. A computer implemented method for remotely managing a device connected on an intranet in real time and on demand, comprising:
opening and maintaining a private and secure communication channel between a management gateway connected on the intranet behind a firewall and a remote management console connected to the internet;
sending a first request message from the remote management console to the management gateway regarding management of the device;
sending a second request message from the management gateway to the device regarding management of the device;
receiving a first response message at the management gateway from the device regarding the response of the device to the second request message from the management gateway;
sending a second response message from the management gateway to the remote management console regarding the response of the device to the second request message.

2. The method of claim 1, further comprising:
preventing the remote management console from accessing any device or application on the intranet except the management gateway.

3. The method of claim 1, wherein said opening and maintaining a private and secure communication channel includes:
Initiating an HTTPS connection from the management gateway to the remote management console and performing mutual authentication.

4. The method of claim 3, wherein said opening and maintaining a private and secure communication channel includes:
employing HTTPS polling to maintain a persistent HTTPS connection.

5. The method of claim 1, wherein said device is a multifunction printing (MFP) device.

6. The method of claim 5, wherein said first request message includes a command for the MFP device to undertake one of the actions selected from the group consisting of a firmware upgrade, a device reboot, a front panel access, a feature cloning, a device cloning, a security dashboard, a status update; a click count, a driver distribution, a supply management, a preventive maintenance, job accounting, and browsing the embedded web page of the MFP device.

7. The method of claim 1, wherein said management gateway is a software application installed on a server connected to the intranet, and said remote management console is a software application installed on a server at a site remote from said intranet.

8. The method of claim 1, further comprising:
sending a communication request message from the remote management console to the management gateway using a second communication channel which is different from said private and secure communication channel; and
wherein said opening and maintaining said private and secure communication channel is performed by said management gateway in response to said communication request message.

9. A method for remotely managing a device connected on a user's intranet behind a user firewall, comprising:
providing a management gateway software application on a server connected on the intranet and which provides management control of the device;
providing a remote management console at a remote site;
sending a communication request message from the remote management console to the management gateway;
in response to the communication request message, using the management gateway to open a private and secure internet communication channel between the management gateway and the remote management console;
sending a first management request message from the remote management console to the management gateway regarding management of the device;
sending a second management request message from the management gateway to the device regarding management of the device.

10. The method of claim 9, further comprising:
receiving a first response message at the management gateway from the device regarding the response of the device to the second request message from the management gateway;
sending a second response message from the management gateway to the remote management console regarding the response of the device to the second request message.

11. The method of claim 9, wherein said communication request message employs one of an IM (instant message), SMS (Simple Messaging Service) and MMS (Multi-media Messaging Service) protocol.

12. The method of claim 11, wherein said opening a private and secure internet communication channel comprises opening an HTTPS connection between the management gateway and the remote management console.

13. The method of claim 12, further comprising sending HTTP polling messages from the management console to the remote management console to maintain the HTTPS connection.

14. The method of claim 10, further comprising:
preventing the remote management console from accessing any device or application on the intranet except the management gateway.

15. A method for remotely managing a network of multifunction printing (MFP) devices connected on a user's intranet behind a user firewall, comprising:
providing a management gateway software application connected on the intranet and which provides management control of the network of MFP devices;
providing a remote management console at a remote site;
sending a communication request message from the remote management console to the management gateway;
in response to the communication request message, using the management gateway to open a secure virtual tunnel between the management gateway and the remote management console;
sending a first management request message through the secure virtual tunnel from the remote management console to the management gateway regarding management of one of the MFP devices;
sending a second management request message through the secure virtual tunnel from the management gateway to the one of the MFP devices regarding management of the one of the MFP devices.

16. The method of claim 15, further comprising:
receiving a first response message at the management gateway from the one of the MFP devices regarding the response of the one or the MFP devices to the second request message from the management gateway;
sending a second response message from the management gateway through the secure virtual tunnel to the remote management console regarding the response of the one of the MFP devices to the second request message.

17. The method of claim 15, wherein said communication request message employs one of an IM (instant message), SMS (Simple Messaging Service) and MMS (Multi-media Messaging Service) protocol.

18. The method of claim 17, wherein said opening a secure virtual tunnel comprises initiating an HTTPS connection from the management gateway to the remote management console.

19. The method of claim 18, further comprising sending HTTP polling messages from the management console to the remote management console to maintain the HTTPS connection.

20. The method of claim 15, further comprising:
preventing the remote management console from accessing any device or application on the intranet except the management gateway.

21. The method of claim 15, wherein said first management request message includes a command for the one of the MFP devices to undertake one of the actions selected from the group consisting of a firmware upgrade, a device reboot, a front panel access, a feature cloning, a device cloning, a security dashboard, a status update; a click count, a driver distribution, a supply management, a preventive maintenance, job accounting, and browsing an embedded web page of the one of the MFP device.
